(19) United States
(12) Patent Application Publication
(10) Pub. No.: US 2009/0269676 A1
(43) Pub. Date: Oct. 29, 2009

(54) NON-AQUEOUS ELECTROLYTES FOR LITHIUM ELECTROCHEMICAL CELLS

(76) Inventor: Thomas J. Barbarich, Westerly, RI (US)

Correspondence Address: MICHAUD-DUFFY GROUP LLP, 306 INDUSTRIAL PARK ROAD, SUITE 206, MIDDLETOWN, CT, 06457, US

(21) Appl. No.: 12/431,792

(22) Filed: Apr. 29, 2009

Related U.S. Application Data
(60) Provisional application No. 61/125,928, filed on Apr. 29, 2008.

(51) Int. Cl. H01M 10/26; H01M 6/16

(52) U.S. Cl. 429/337; 429/207; 429/200; 429/203; 429/324; 429/343

(57) ABSTRACT

A non-aqueous electrolyte for an electric current producing electrochemical cell is provided comprising an ionically conductive salt and an additional ionically conducting salt in a non-aqueous medium, the additional ionically conducting salt corresponding to the formula M⁺(Z*(J*)j)⁻, wherein: M is a lithium atom, Z* is an anion group containing two or more Lewis basic sites and comprising less than 50 atoms not including hydrogen atoms, J* independently each occurrence is a Lewis acid coordinated to at least one Lewis basic site of Z*, and optionally two or more such J* groups may be joined together in a moiety having multiple Lewis acidic functionality, and j is an integer from 2 to 12. The addition of these ionically conducting salts to electrolyte solutions containing LiPF₆ (and/or other lithium compounds) improves the stability of the electrolyte solution.

### CROSS REFERENCE

This application claims the benefits of U.S. Provisional Application No. 61/125,928, filed on Apr. 29, 2008, entitled “Conductive salts for the thermal stabilization of non-aqueous electrolytes for lithium electrochemical cells using LiPF6,” the contents of which are incorporated herein by reference in its entirety.

### FIELD OF THE INVENTION

This invention relates to non-aqueous electric current producing electrochemical cells in general and more particularly to both primary and secondary lithium cells employing non-aqueous electrolytes containing an additive lithium salt and LiPF₆ which are highly ionically conductive and which exhibit good thermal stability.

### BACKGROUND OF THE INVENTION

One attractive class of modern high energy density rechargeable cells is the Lithium-ion (Li-ion) cell. The principle components of a Li-ion cell are an anode which is typically composed of a graphitic carbon anode, for example, natural or artificial graphite, or a low voltage transition metal oxide such as a lithium titanate, a cathode which is typically composed of a transition metal oxide cathode such as LiCoO₂ or lithium metal phosphates such as LiFePO₄, and a highly conductive electrolyte solution. The electrolyte provides mobility to the Li ions, which are transported from the anode to the cathode, and vice versa, during discharge and charge of the battery. The electrolyte in a Li-ion cell is composed of a lithium salt that is dissolved in a nonaqueous solvent such as an organic carbonate(s). To a large extent, the salt used in the electrolyte of the cell governs the overall performance of the cell and the salt must therefore meet certain requirements. In terms of performance, a salt must have high conductivity, high thermal stability, and electrochemical stability above the potential of the fully charged cell, and be nontoxic and safe.

Unfortunately, no salts adequately meet all the cost, performance, and safety requirements imposed by the industry. The most common salt in use today is LiPF₆, which is added to organic carbonate solvent mixtures to form the electrolyte solution. This salt has excellent conductivity and electrochemical stability in these solvents but is expensive. In addition, this salt is limited to an operational temperature range of −40° C. to +50° C. The LiPF₆ is thermally unstable and is believed to decompose at temperatures above 60° C. according Equation 1 below.

$${LiPF}_{6} {}^{Δ} LiF + {PF}_{5} \qquad ( Equation 1 )$$

In addition, both LiPF₆ and PF₅ are susceptible to hydrolysis and, as a result, they will react with any moisture in the electrolyte according to Equations 2 and 3 to form HF.

LiPF₆+H₂O→POF₃+2HF+LiF (Equation 2)

PF₅+H₂O→POF₃+2HF (Equation 3)

The HF and PF₅ can catalyze the decomposition of the solvents, react with the electrodes to increase the electrode/electrolyte interfacial impedance, and corrode the current collectors. Other lithium salts based on perfluorinated inorganic anions with the general formula LiMFₓ, have been extensively studied. The order of conductivity of these salts is LiSbF₆>LiAsF₆≈LiPF₆>LiBF₄. However, each of these salts has either poor electrochemical stability (LiSbF₆), toxicity (LiAsF₆), or poor cycling efficiency (LiBF₄).

The recent development of several organic anions, some of which have high conductivities, has overcome some of the performance problems with the inorganic anions. The most promising group of these anions is that based on fluorinated sulfonyl ligands. The Li salt of N(SO₂CF₃)₂⁻, for example, is highly conductive and thermally stable to 360° C. However, it has been reported to corrode aluminum at high potentials which is a problem for cells employing aluminum current collectors. Other related salts being investigated include LiC(SO₂CF₃)₃ and those obtained by the substitution of various fluorinated organic groups (R) on LiN(SO₂R)₂. While these anions have promising performance characteristics, they are expensive.

U.S. Pat. Application No. 20040091772 discloses that the thermal stability of the electrolyte containing LiPF₆ may be improved through the addition of a few percent of a Lewis base to electrolyte solution. It is believed that the Lewis base forms a complex with PF₅, POF₃, and other Lewis acidic species from the decomposition of LiPF₆ at elevated temperatures. This prevents these Lewis acidic species from further catalyzing the decomposition of the electrolyte.

U.S. Pat. No. 6,852,446 issued to Barbarich on Feb. 8, 2005 discloses the preparation and use of new lithium salts for Li-ion batteries. The salts are prepared from the combination of an anion having a 1-charge that has multiple Lewis basic sites and a sufficient quantity of a Lewis acid such that all the Lewis basic sites of the anion are complexed. These salts are also highly conductive although not as high as LiPF₆. The salts were used in a Li-ion cell with no other salt present and cycled 50 times with high coulombic efficiency demonstrating compatibility with traditional Li-ion battery materials including the carbon anode, lithium transition metal oxides, and the current collectors. It was further reported by Barbarich, et. al in Inorganic Chemistry, 2004, 43, 7764-7773 that these salts partially disproportionate and reach an equilibrium at elevated temperatures. It is believed that the disproportionation mechanism involves the formation of a Lewis basic species during the first step with the loss of BF₃ as shown for the parent imidazole based salt in FIG. 1. The results of these studies indicate an improve performance at higher temperatures above 120 degrees F.

### SUMMARY OF THE INVENTION

A non-aqueous electrolyte for an electric current producing electrochemical cell is provided comprising an ionically conductive salt and an additional ionically conducting salt disclosed in U.S. Pat. No. 6,852,446 in a non-aqueous medium, the salt additive corresponding to the formula:

M⁺(Z*(J*)j)⁻,

wherein: M is a lithium atom, Z* is an anion group containing two or more Lewis basic sites and comprising less than 50 atoms not including hydrogen atoms, J* independently each occurrence is a Lewis acid coordinated to at least one Lewis basic site of Z*, and optionally two or more such J* groups may be joined together in a moiety having multiple Lewis acidic functionality, j is an integer from 2 to 12.

The present invention is based on the unexpected discovery that that the combination of the ionically conducting salts disclosed in U.S. Pat. No. 6,852,446 may be combined with other salts used in Li-ion electrolytes to form highly conductive solutions which provide better stability at temperatures above 120 degrees F. Such salt mixtures in within a non-aqueous liquid medium may have different properties than the individual salt in a non-aqueous liquid medium. These mixtures may have different conductivity, thermal stability, and/or stabilize other cell components. The proposed disproportionation mechanism of these anions at elevated temperature shown in FIG. 1 yields a Lewis basic species that is believed to react with the Lewis acidic species that are also generated from the decomposition of LiPF₆ at these temperatures. Such reactions are expected to prevent further degradation of the electrolyte by removing the Lewis acids that are responsible for autocatalytic decomposition of the electrolyte as described in [J. Electrochem. Soc. 2005. 152(12): p. A2327.]

The aforementioned salts may be combined with other salts used in Li-ion electrolytes which include but is not limited to: LiPF₆, LiBF₄, LiAsF₆, LiSbF₆, LiClO4, LiAlCl₄, LiGaCl₄, LiNO₃, LiC(SO₂CF₃)₃, LiN(SO₂CF₃)₂, LiN(SO₂CF₂CF₃)₂, LiSCN, LiO₃SCF₂CF₃, LiC₆F₅SO₃, LiO₂CCF₃, LiSO₃F, LiB(C₆H₅)₄, LiCF₃SO₃, LiB(C₂O₄)₂, and mixtures thereof. Other classes of salts, which are described in [Chemical Reviews, 2004, 104, 4303-4417] that are included are aromatic lithium borates, nonaromatic lithium borates, lithium azolates, lithium chelatophosphates, and lithium fluoroalkylphosphates. The salt mixtures may be incorporated within a non-aqueous liquid medium such as, for example, an organic solvent. The salt may also be employed with various polymers and gels as the non-aqueous medium. The non-aqueous cell electrolyte of the present invention is useful in both primary and secondary lithium cells. The cell electrolyte is compatible with other cell components and generally exhibits desirable conductivity and thermal stability. The electrolyte is furthermore relatively easy to prepare and inexpensive to use in typical lithium cells.

### BRIEF DESCRIPTION OF THE DRAWINGS

FIG. 1 illustrates the disproportionation mechanism for one of the salt additives.

FIG. 2 shows test data for two lots of 8 cells each that were activated either with baseline LiPF₆ electrolyte or with the same electrolyte containing 5% by weight of the lithium bis(trifluoroborane)imidazolide (LiIm(BF₃)₂) salt additive. Two groups of test data, pre- and post-stabilization are shown for each cell.

### DETAILED DESCRIPTION OF THE INVENTION

It has been discovered in accordance with the present invention that non-aqueous, primary and secondary, electric current producing electrochemical cells having desirable performance characteristics can be prepared at relatively low costs by employing conductive lithium salts, e.g., those described in U.S. Pat. No. 6,852,446, as additives in combination with LiPF₆ and/or other lithium salts in various non-aqueous mediums as the cell electrolyte. It was further found that mixtures of this novel class of salts with LiPF₆ and/or other salts used in a non-aqueous medium improves the stability of this electrolyte solution at temperatures above 120 degrees F. The additive conductive lithium salts correspond to the general formula:

M⁺(Z*(J*)j)⁻,

wherein:
M is a lithium atom,
Z* is an anion group containing two or more Lewis basic sites and comprising less than 50 atoms not including hydrogen atoms,
J* independently each occurrence is a Lewis acid coordinated to at least one Lewis basic site of Z*, and optionally two or more such J* groups may be joined together in a moiety having multiple Lewis acidic functionality,
j is an integer from 2 to 12.
Z* can be any anionic moiety having a 1-overall charge and containing two or more Lewis basic sites. Preferably, the Lewis base sites are on different atoms of a polyatomic anionic moiety. Desirably, such Lewis basic sites are relatively sterically accessible to the Lewis acid, J*. Preferably the Lewis basic sites are on nitrogen atoms or carbon atoms. Examples of suitable Z* anions include cyanide, azide, amide, amidinide, substituted amidinide, dicyanamide, imidazolide, substituted imidazolide, imidazolinide, substituted imidazolinide, benzoimidazolide, substituted benzoimidazolide, tricyanomethide, tetracyanoborate, puride, squarate, 1,2,3-triazolide, substituted 1,2,3-triazolide, 1,2,4-triazolide, substituted 1,2,4-triazolide, pyrimidinide, substituted pyrimidinide, tetraimidazoylborate, substituted tetraimidazoylborate, tris(imidazoyl)fluoroborate, substituted tris(imidazoyl)fluoroborate, bis(imidazoyl)difluoroborate, substituted bis(imidazoyl)difluoroborate anions and mixtures thereof, wherein each substituent, if present, is selected from the group consisting of a halo, hydrocarbyl, halohydrocarbyl, silyl, silylhydrocarbyl, a halocarbyl group of up to 20 atoms not counting hydrogen and mixtures thereof, and further wherein two substituents, if present, together form a saturated or unsaturated ring system. Preferred Z* groups are imidazolide, 2-methylimidazolide, 4-methylimidazolide, benzoimidazolide, and dimethylamide.

Coordinated to the Lewis base sites of the anion are from 2 to 12 Lewis acids, J*, two or more of which may be joined together in a moiety having multiple Lewis acid functionality. Preferably, from 2 to 4 J* groups having from 3 to 100 atoms are present. Preferred Lewis acids are those having a formula selected from the group consisting of (¹R)₃M, (R¹)₂-M*-(Ar^{f}—Ar^{f})-M*-(R¹)₂, (R¹)-M*-(Ar^{f1}—Ar^{f2})₂-M*-(R¹), M*-(Ar^{f1}—Ar^{f2})₃-M* as well as mixtures thereof

wherein:
M* is aluminum or boron;
R¹ independently each occurrence is a compound selected from the group consisting of a halide, alkyl, aryl, alkoxide, aryloxide, dialkylamido, halogenated alkyl, halogenated aryl, halogenated alkoxide, halogenated aryl oxide and mixtures thereof, said R¹ having up to twenty carbon atoms, and Ar^{f1}—Ar^{f2} in combination is independently, a divalent aromatic group of 6 to 20 carbon atoms.

Highly preferred Lewis acids are BR¹₃ and AlR¹₃ wherein R¹ independently each occurrence is selected from the group consisting of a halogen, alkoxide, fluorinated alkoxide, halogenated alkyl, halogenated aryl and mixtures thereof, R¹ having up to 20 carbon atoms. In a more highly preferred embodiment, R¹ is a fluorine atom.

The foregoing lithium salts (illustrated by those having imidazolide, substituted imidazolide, benzoimidazolide, substituted benzoimidazolide, and amide) may be depicted below as follows:

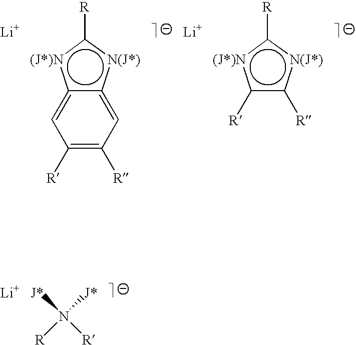

wherein: Li is lithium, R, R′, and R″ are hydrogen or hydrocarbyl group, and J* is a Lewis acid, for example, BF₃, B(OCH₃)₃, B(C₆F₅)₃, or B(OCH(CF₃)₂)₃.

Examples of the preferred lithium salts include lithium salts of bis(trifluorborane)imidazolide, bis(trifluorborane)-2-methylimidazolide, bis(trifluorborane)-4-methylimidazolide, bis(trifluorborane)-2-isopropylimidazolide, bis(trifluorborane)benzimidazolide, bis(trifluorborane)dimethylamide, bis(trifluoroborane)diisopropylamide, bis(trimethoxyborane)imidazolide, bis(trimethoxyborane)-2-methylimidazolide, bis(trimethoxyborane)-4-methylimidazolide, bis(trimethoxyborane)-2-isopropylimidazolide, bis(trimethoxyborane)benzimidazolide, bis(trimethoxyborane)dimethylamide, bis(trimethoxyborane)diisopropylamide, tetrakis(trifluoroborane)tetraimidazoylborate, tris(trifluoroborane)triimidazoylfluoroborate, bis(trifluoroborane)diimidazoyldifluoroborate, tetrakis(trifluoroborane)tetrakis(dimethylamino)borate, tris(trifluoroborane)tris(dimethylamino)fluoroborate, and bis(trifluoroborane)bis(dimethylamino)difluoroborate, which are present in the electrolyte in a concentration of about 0.001M to about 0.30M. Examples of highly preferred salts include lithium salts of bis(trifluoroborane)imidazolide, bis(trifluoroborane)-2-methylimidazolide, bis(trifluoroborane)-4-methylimidazolide, or bis(trifluoroborane)-2-isopropylimidazolide, bis(trifluoroborane)benzimidazolide at a concentration up to 0.05 M.

The foregoing lithium salts (illustrated, for example, by those having imidazolide, substituted imidazolide, benzoimidazolide, substituted benzoimidazolide, and amide) may be combined with other salts used in Li-ion electrolytes which include but is not limited to: LiPF₆, LiBF₄, LiAsF₆, LiSbF₆, LiClO4, LiAlCl₄, LiGaCl₄, LiNO₃, LiC(SO₂CF₃)₃, LiN(SO₂CF₃)₂, LiN(SO₂CF₂CF₃)₂, LiSCN, LiO₃SCF₂CF₃, LiC₆F₅SO₃, LiO₂CCF₃, LiSO₃F, LiB(C₆H₅)₄, LiCF₃SO₃, LiB(C₂O₄)₂, and mixtures thereof. Other classes of salts, which are described in [Chemical Reviews, 2004, 104, 4303-4417] that are included are aromatic lithium borates, nonaromatic lithium borates, lithium azolates, lithium chelatophosphates, and lithium fluoroalkylphosphates.

It has been discovered that these compounds, when added to an appropriate solvent, form a useful electrolyte for lithium and Li-ion batteries and stabilize a LiPF₆ bearing electrolyte. Suitable solvents include non-aqueous liquid polar solvents such as organic carbonates including ethylene carbonate, dimethyl carbonate ethylmethyl carbonate, diethyl carbonate and mixtures thereof. Other solvents which may be in a mixture with organic carbonates are organic ethers, lactones, such as gamma-butyrolactone, formates, esters, sulfones, nitriles, and oxazolidinones which are used in primary and secondary Li batteries.

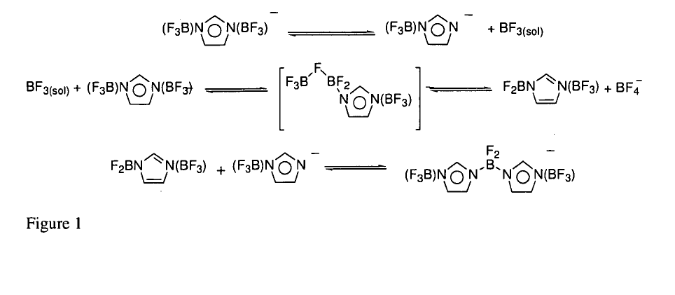

Without being bound by any theory, it is believed the salts described in U.S. Pat. No. 6,852,446 will stabilize LiPF₆ solutions (LiPF₆ bearing electrolytes) because they undergo a partial disproportionation reaction at approximately the same temperatures as LiPF₆. One of the intermediate species of disproportionation, the anionic Lewis base formed in the first step of the disproportionation mechanism in FIG. 1 from the loss of the Lewis acid such as BF₃, is believed to react with the Lewis acidic species formed from the decomposition of LiPF₆ that are responsible for autocatalytic decomposition of the electrolyte. These salts will provide the necessary Lewis base to stabilize LiPF₆ based electrolytes at elevated temperatures and will therefore enhance the stability of these electrolytes similar to the Lewis bases described in U.S. Pat. Application No. 20040091772. However, these salts, unlike the Lewis bases described in US Pat. Application No. 20040091772, will also contribute to the overall Li-ion mobility in the electrolyte since they are also ionic conductors in suitable electrolyte solvents.

These electrolytes may be used in primary cells, which have an anode and cathode as components of the cell. Typical anode materials which may be used in primary cells are lithium, lithium alloys, lithium carbon intercalated compounds, lithium graphite intercalation compounds, lithium metal oxide intercalation compounds, and mixtures thereof. The cathode in a primary cell is typically composed of a transition metal oxide, a transition metal chalcogenide, a poly(carbondisulfide) polymer, an organo-disulfide redox polymer, a polyaniline, an organodisulfide/polyaniline composite and an oxychloride. Examples of materials that may be used as a cathode in a primary cell include SO₂, CuO, CuS, Ag₂ CrO₄, I₂, PbI₂, PbS, SOCl₂, V₂O₅, MoO₃, MnO₂, and poly(carbon monofluoride), (CF)ₙ. Typically, organic solvents such as acetonitrile and propylene carbonate and inorganic solvents, such as thionyl chloride are used in primary cells.

The compounds have been found to be useful in secondary (rechargeable) cells. A secondary lithium or lithium-ion battery has a cathode and anode, one of which has lithium incorporated into it. The anode for these cells is capable of reversibly incorporating lithium metal. Examples of these materials include lithium metal, lithium alloys, lithium-carbon or lithium-graphite intercalation compounds, lithium metal oxide intercalation compounds such as LiₓWO₂ or LiMoO₂ or a lithium metal sulfide such as LiTiS₂. The cathode material is also capable of reversibly incorporating lithium metal. Suitable cathode materials include transition metal oxides, metal phosphates, and transition metal chalogenides, examples of which are LiNi_{0.8}Co_{0.2}O₂, Li_{2.5}V₆O₁₃, Li_{1.2}V₂O₅, LiCoO₂, LiFePO₄, LiNiO₂, LiMn₂O₄, LiMnO₂, Li₃NbSe₃, LiTiS₂, and LiMoS₂.

In assembling the cell of the present invention, the cathode is typically fabricated by depositing a slurry of the cathode material, a electrically conductive inert material, the binder, and a liquid carrier on the cathode current collector, and then evaporating the carrier to leave a coherent mass in electrical contact with the current collector.

In assembling a cell of the present invention, the anode can similarly be fabricated by depositing slurry of the highly graphitic carbonaceous anode material, the electrically conductive inert material, the binder, and a liquid carrier on the anode current collector, and then evaporating the carrier to leave a coherent mass in electrical contact with the current collector.

The cathode assembly is then combined with the anode assembly with the porous non-conducting separator sandwiched between these two assemblies. Suitable porous non-conducting separator materials include microporous polyethylene film and a porous glass membrane, for example. The preferred way of constructing high voltage rechargeable cells is to make them with the cathode in the discharged state because the material is stable in air. In a Li-ion cell employing a carbonaceous anode material, this material is also in a discharged state during cell assembly. The layered assembly is then wound around a metal post which may serve as terminal for the cell. Alternatively, several of these layers maybe assembled together to form a prismatic cell. After assembly of the electrode materials in the cell, the electrolyte solution in which the salt is dissolved is added. The cell container is then capped.

The electrolyte solution of the present invention includes the additive salt and another salt dissolved in the electrolyte solvent. Suitable electrolyte solvents include non-aqueous liquid polar solvents such as ethylene carbonate, dimethyl carbonate, ethylmethyl carbonate, diethyl carbonate, and mixtures thereof. Other solvents are organic carbonates, lactones, formates, esters, sulfones, nitrites, and oxazolidinones.

There are several types of polymer electrolytes that may be useful in electrochemical cells of the present invention. One type consists of lithium salts dissolved in linear polyethers such as polyethylene oxide which may have branched or comb shaped polymers which have flexible inorganic backbones such as (—P═N—)ₙ, or (—SiO—)ₙ. Polymer electrolytes may be further modified by addition of additives such as plasticizers such as organic carbonates.

Gelled electrolytes are another type of electrolyte that is useful for the electrochemical cells of this invention. Gelled electrolytes include a solution of a lithium salt in a liquid organic solvent and a supporting matrix of a polymer such as poly(acrylonitrile) (PAN) or poly(vinylidene fluoride-hexafluoro-propylene) (PVDF-HFP) copolymer. Solvent mixtures such as binary or ternary mixtures of organic carbonates can also be used as liquid solvents in gelled electrolytes.

### EXPERIMENTAL

All preparations and physical measurements were carried out with rigorous exclusion of air and water. Schienk and glovebox techniques were employed with purified argon used as an inert gas when required. All reagents and solvents were reagent grade or of higher quality. Imidazole, was purchased from Aldrich and used as received. Boron trifluoride diethyl etherate were both purchased from Alfa Aesar and used as received. The following solvents were dried by distillation from the indicated drying agent: dichloromethane (P₂O₅), toluene (Na), and acetone (4 Å molecular sieves). Ethylmethyl carbonate (<30 ppm H₂O), ethylene carbonate (<30 ppm H₂O), diethyl carbonate (<15 ppm H₂O, and dimethyl carbonate (<15 ppm H₂O) were purchased from EM Science and used as received.

### Example 1

Storage stability of LiPF₆ mixture with lithium bis(trifluoroborane)imidazolide (LiIm(BF₃)₂). An electrolyte solution was prepared by dissolving LiIm(BF₃)₂ (0.262 g, 1.25 mmol) and lithium hexafluorophosphate (3.61 g, 23.75 mmol) in 1/1/1 EC/DMC/DEC (wt %) to yield a 25 mL solution that was 1 M in Li⁺. A five mL aliquot was sealed in glass ampoules under an argon atmosphere. For comparison, a 1 M lithium hexafluorophosphate solution in 1/1/1 EC/DMC/DEC was similarly prepared and sealed in a glass ampoule. Both were then stored at 80° C. After one day the LiPF₆ solution darkened considerably and after 4 days the ampoule burst from excessive gas pressure generated by decomposing electrolyte. The solution with the lithium bis(trifluoroborane)imidazolide salt additive had no visible change after one day and only very slight darkening after one week.

### Example 2

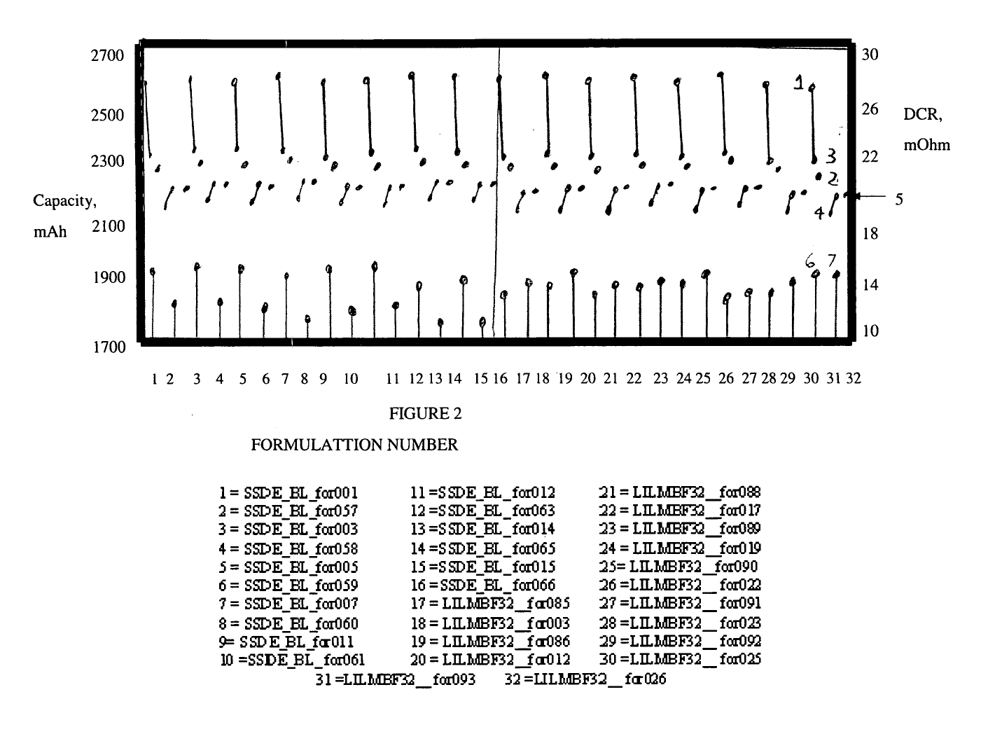

Cell testing. Two lots of 8 cells each were assembled and activated either with baseline LiPF₆ electrolyte or with the same electrolyte containing 5% by weight of the LiIm(BF₃)₂ salt additive. The active anode material used was a carbon based material and the active cathode material was LiFePO₄, which were each coated onto copper and aluminum foil, respectively. The cells went through the normal formation and stabilization procedure. Two groups of test data, pre- and post-stabilization are shown for each cell in FIG. 2. No additional/excessive irreversible capacity loss (pts. 1, 3, 4 and 5) was caused by the salt. The 5 A (2.3 C) discharge capacity (pt. 2) was affected very little as was capacity loss after stabilization (pt. 4).

Those skilled in the art will appreciate that numerous changes and modifications may be made to the preferred embodiments of the invention and that such changes and modifications may be made with out departing from the spirit of the invention. It is therefore intended that the appended claims cover all such equivalent variations as those which fall within the true spirit of the invention.

What is claimed is:

1. A non-aqueous electrolyte for an electric current producing electrochemical cell, said electrolyte comprising:
a first ionically conducting salt and a second ionically conducting salt in a non-aqueous medium wherein the second ionically conducting salt corresponds to the formula: M⁺(Z*(J*)j)⁻, wherein:
M is a lithium atom,
Z* is an anion group containing two or more Lewis basic sites,
J* is independently a Lewis acid coordinated to at least one Lewis basic site of Z*, and optionally two or more such J* groups may be joined together in a moiety having multiple Lewis acidic functionality,
j is an integer from 2 to 12.

2. The non-aqueous electrolyte according to claim 1 wherein said Z* is selected from the group consisting of cyanide, azide, amide, amidinide, and substituted amidinide, dicyanamide, imidazolide, substituted imidazolide, imidazolinide, substituted imidazolinide, tricyanomethide, tetracyanoborate, puride, squarate, 1,2,3-triazolide, substituted 1,2,3-triazolide, 1,2,4-triazolide, substituted 1,2,4-triazolide, pyrimidinide, substituted pyrimidinide, tetraimidazoylborate and substituted tetraimidazoylborate, tris(imidazoyl)fluoroborate and substituted tris(imidazoyl)fluoroborate, bis(imidazoyl)difluoroborate and substituted bis(imidazoyl)difluoroborate anions, wherein each substituent, if present, is also a halo, hydrocarbyl, halohydrocarbyl, silyl, silylhydrocarbyl, or halocarbyl group of up to 20 atoms not counting hydrogen, or two substituents together form a saturated or unsaturated ring system.

3. The non-aqueous electrolyte according to claim 1 wherein said J* corresponds to the formula: 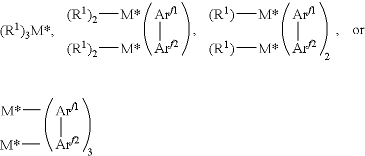
wherein:
M* is aluminum or boron;
each R¹ is independently halide, alkyl, aryl, alkoxide, aryloxide, dialkylamido, halogenated alkyl, halogenated aryl, halogenated alkoxide, or halogenated aryl oxide, and
Ar^{f1}—Ar^{f2} in combination is independently, a divalent aromatic group.

4. The non-aqueous electrolyte according to claim 3 wherein said J* corresponds to the formula:
BR¹₃ or AlR¹₃ wherein:
each R¹ is a halogen, a C₁₋₂₀ alkyl, halogenated alkyl, alkoxide or aryloxide.

5. The non-aqueous electrolyte according to claim 4 wherein said R¹ is a halogen.

6. The non-aqueous electrolyte according to claim 4 wherein said R¹ is a fluorinated alkyl or fluorinated aryl.

7. The non-aqueous electrolyte according to claim 4 wherein said R¹ is a fluorinated alkoxide or fluorinated aryl oxide.

8. The non-aqueous electrolyte according to claim 5 wherein said R¹ for each occurrence is fluorine.

9. The non-aqueous electrolyte according to claim 6 wherein said R¹ is CF₃, C₆F₅, or (CF₃)₂C₆H₃.

10. The non-aqueous electrolyte according to claim 7 wherein said R¹ is CF₃CH₂O, C₃F₇CH₂O, (CF₃)₂CHO, (CF₃)₂(CH₃)CO, (CF₃)₂(C₆H₅)CO, (CF₃)₃CO, FC₆H₄O, F₂C₆H₃O, F₃C₆H₂O, F₄C₆HO, C₆F₅O, (CF₃)C₆H₄O, or (CF₃)₂C₆H₃O and mixtures thereof.

11. The non-aqueous electrolyte according to claim 1 wherein the second ionically conducting salt is the lithium salt of bis(trifluoroborane)imidazolide, bis(trifluoroborane)-2-methylimidazolide, bis(trifluoroborane)-4-methylimidazolide, bis(trifluoroborane)-2-isopropylimidazolide, bis(trifluoroborane)benzimidazolide, bis(trifluoroborane)dimethylamide, bis(trifluoroborane)diisopropylamide, bis(trimethoxyborane)imidazolide, bis(trimethoxyborane)-2-methylimidazolide, bis(trimethoxyborane)-4-methylimidazolide, bis(trimethoxyborane)-2-isopropylimidazolide, bis(trimethoxyborane)benzimidazolide, bis(trimethoxyborane)dimethylamide, bis(trimethoxyborane)diisopropylamide, tetrakis(trifluoroborane)tetraimidazoylborate, tris(trifluoroborane)triimidazoylfluoroborate, bis(trifluoroborane)diimidazoyldifluoroborate, tetrakis(trifluoroborane)tetrakis(dimethylamino)borate, tris(trifluoroborane)tris(dimethylamino)fluoroborate, or bis(trifluoroborane)bis(dimethylamino)difluoroborate.

12. The non-aqueous electrolyte according to claim 1 wherein Z* is selected from the group consisting of imidazolide, 2-methylimidazolide, 4-methylimidazolide, 2-isopropylimidazolide, benzoimidazolide, dimethylamide, diethylamide, and mixtures thereof.

13. The non-aqueous electrolyte according to claim 1 wherein the second ionically conducting salt is present in the electrolyte in a range of about 0.001M to about 0.30M.

14. The nonaqueous electrolyte according to claim 1 wherein the second ionically conducting salt is a lithium salt of bis(trifluoroborane)imidazolide, bis(trifluoroborane)-2-methylimidazolide, bis(trifluoroborane)-4-methylimidazolide, or bis(trifluoroborane)-2-isopropylimidazolide, bis(trifluoroborane)benzimidazolide at a concentration up to 0.05 M.

15. The non aqueous electrolyte according to claim 1 wherein said first ionically conducting salt is selected from LiPF₆, LiBF₄, LiAsF₆, LiSbF₆, LiCIO4, LiAlCl₄, LiGaCl₄, LiNO₃, LiC(SO₂CF₃)₃, LiN(SO₂CF₃)₂, LiN(SO₂CF₂CF₃)₂, LiSCN, LiO₃SCF₂CF₃, LiC₆F₅SO₃, LiO₂CCF₃, LiSO₃F, LiB(C₆H₅)₄, LiCF₃SO₃, LiB(C₂O₄)₂, and mixtures thereof.

16. The non aqueous electrolyte according to claim 1 wherein said second ionically conducting salt is either a single salt or a mixture of salts in which each of said salts in said mixture corresponds to the formula: M⁺Z*(J*)j).

17. The non aqueous electrolyte according to claim 1, wherein said non aqueous medium is selected from the group consisting of non-aqueous liquid polar solvents, solid polymers, and polymer gels.

18. The non aqueous electrolyte according to claim 17 wherein said non-aqueous liquid polar solvent is an organic solvent selected from the group consisting of ethers, esters, carbonates, sulfones, nitrites, formates, lactones, and mixtures thereof.

19. The non aqueous electrolyte according to claim 18 wherein said organic solvent is selected from the group consisting ethylene carbonate, propylene carbonate, and dialkylcarbonates of the general formula R¹OCOOR² where R¹ and R² are selected independently from a C₁-C₄ alkyl.

20. The non aqueous electrolyte according to claim 19 wherein said dialkylcarbonate is selected from the group consisting of dimethylcarbonate, diethylcarbonate, and ethylmethylcarbonate.

21. The non aqueous electrolyte according to claim 18 wherein said non-aqueous liquid polar solvent is an ether selected from the group consisting of diethyl ether, 1,2-dimethoxyethane, tetrahydrofuran, dioxolane, and mixtures thereof.

22. The non aqueous electrolyte according to claim 18 wherein said lactone is gamma-butyrolactone.
